(19) United States
(12) Patent Application Publication
(10) Pub. No.: US 2018/0003315 A1
(43) Pub. Date: Jan. 4, 2018

(54) LEVER FLOAT VALVE

(71) Applicant: Weir Minerals Australia Ltd, New South Wales (AU)

(72) Inventor: David Reed, New South Wales (AU)

(21) Appl. No.: 15/540,210

(22) PCT Filed: Dec. 21, 2015
(86) PCT No.: PCT/AU2015/050822

§ 371 Date: Jun. 27, 2017

(30) Foreign Application Priority Data
Jan. 7, 2015 (AU) 2015900025

(51) Int. Cl. F16K 31/32; B60K 15/03; F16K 21/18

(52) U.S. Cl. CPC F16K 31/32; F16K 21/18; B60K 15/03; B60K 2015/03289

(57) ABSTRACT

A lever float valve comprising a float stem with a central vertical axis; a float body coupled to the float stem and rotatable relative to the central vertical axis of the float stem; a valve segment positioned within the float body and configured to pivot around a first axis perpendicular to the vertical axis; and a lever comprising a float arm and a float coupled to the valve segment and configured to pivot around a second axis perpendicular to the vertical axis.

### FIELD OF THE DISCLOSURE

The present disclosure relates to devices for detecting a fluid level and more particularly, to lever float valves for detecting a fluid level in a container.

### BACKGROUND OF THE DISCLOSURE

Lever float valves are products designed for use as an actuator. For example, the lever float valve could be used in a fast filling situation such as for a diesel fuel tank to shut off the flow of diesel fuel when the tank is full. However, these lever float valves are generally limited being used on stationary equipment (for example, pumps, lighting towers and generator sets).

As a result of their design, typical lever float valves are generally not used in mobile situations. In fact, many manufacturers specifically indicate the valve should not be used on mobile equipment or any equipment where the tank is moved with fuel inside. Another shortcoming of typical lever float valves is that placement of the unit needs to consider the side wall and baffles of the fuel tank because of its pivot design—a limitation for its use, especially in retrofit applications. Accordingly, it is desirable to design a new lever float valve which is capable of being used in applications where the equipment is mobile and/or lacks baffling.

### SUMMARY OF THE DISCLOSURE

Exemplary embodiments described herein may provide a lever float valve which is capable of being used in mobile applications and/or within tanks that comprise little to no baffling.

Exemplary embodiments described herein may provide a lever float valve with a pivot mechanism which allows positive shut off against significantly higher head pressures without effecting buoyancy.

Exemplary embodiments described herein may provide a lever float valve with a mechanism that enables the lever arm to swivel around a vertical access.

Exemplary embodiments described herein may provide a lever float valve comprising a swivel feature designed to reduce fuel surge inside tanks when they are moved.

Exemplary embodiments described herein may provide a lever float valve comprising a shear mechanism to produce fuel shut off, thereby allowing the device to withstand higher fuel pressures.

Exemplary embodiments described herein may provide for a lever float valve comprising: a float stem with a central vertical axis; a float body coupled to the float stem and rotatable relative to the central vertical axis of the float stem; a valve segment positioned within the float body and configured to pivot around a first axis perpendicular to the vertical axis; and a lever comprising a float arm and a float coupled to the valve segment and configured to pivot around a second axis perpendicular to the vertical axis.

In exemplary embodiments the rotation of the valve segment may be independent of the rotation of the lever.

In exemplary embodiments the first axis and the second axis may be positioned within the float body.

In exemplary embodiments the lever float valve may be configured to substantially stop the flow of fluid through the float stem when a fluid level in a tank reaches a predetermined height.

In exemplary embodiments the lever float valve may be mountable in a stationary tank.

In exemplary embodiments the lever float valve may be mountable in a movable tank.

In exemplary embodiments, in operation, the valve segment may rotate around the first axis to open and close a first valve aperture and the lever may rotate around a second axis to open and close a second valve aperture.

In exemplary embodiments, in operation, the first valve aperture and the second valve aperture may be open when the fluid level is below a first predetermined level, the second valve aperture may close when the fluid level is above the first predetermined level, the second valve aperture may open when the fluid level is above a second predetermined level higher than the first predetermined level, the first valve aperture may close when the fluid level is above a third predetermined level higher than the second predetermined level, and the second valve aperture may close when the fluid level is above a fourth predetermined level higher than the third predetermined level.

In exemplary embodiments the valve segment further comprises a seal plug configured to engage a portion of the float body to substantially seal the first valve aperture closed.

In exemplary embodiments the lever float valve further comprises a ball configured to substantially seal the second valve aperture closed when the lever forces the ball into the second valve aperture.

In exemplary embodiments, in operation, the lever float valve may open when the fluid level falls below a predetermined level allowing the lever to pivot such that the second valve aperture opens thereby causing the seal plug to disengage with the float body so the valve segment is allowed to rotate.

In exemplary embodiments the fluid flow through the first valve aperture may be significantly greater than the fluid flow through the second valve aperture.

Exemplary embodiments described herein may provide for a lever float valve, mountable to a movable fuel tank, the lever float valve comprising: a float stem with a central vertical axis; a float body coupled to the float stem and rotatable relative to the central vertical axis of the float stem; a valve segment positioned within the float body and configured to pivot around a first axis perpendicular to the vertical axis to open and close a first valve aperture; and a lever comprising a float arm and a float coupled to the valve segment and configured to pivot around a second axis perpendicular to the vertical axis to open and close a second valve aperture; wherein the fuel flow through the first valve aperture is significantly greater than the fuel flow through the second valve aperture.

In exemplary embodiments the rotation of the valve segment may be independent of the rotation of the lever.

In exemplary embodiments the first axis and the second axis may be positioned within the float body.

In exemplary embodiments the lever float valve may be configured to substantially stop the flow of fuel through the float stem when a fluid level in the fuel tank reaches a predetermined height.

In exemplary embodiments, in operation, the first valve aperture and the second valve aperture may be open when the fluid level is below a first predetermined level, the second valve aperture may close when the fluid level is above the first predetermined level, the second valve aperture may open when the fluid level is above a second predetermined level higher than the first predetermined level, the first valve aperture may close when the fluid level is above a third predetermined level higher than the second predetermined level, and the second valve aperture may close when the fluid level is above a fourth predetermined level higher than the third predetermined level.

In exemplary embodiments the valve segment further comprises a seal plug configured to engage a portion of the float body to substantially seal the first valve aperture closed.

In exemplary embodiments the lever float valve further comprises a ball configured to substantially seal the second valve aperture closed when the lever forces the ball into the second valve aperture.

In exemplary embodiments, in operation, the lever float valve may open when the fluid level falls below a predetermined level allowing the lever to pivot such that the second valve aperture opens thereby causing the seal plug to disengage with the float body so the valve segment is allowed to rotate.

Other aspects, features, and advantages will become apparent from the following detailed description when taken in conjunction with the accompanying drawings, which are a part of this disclosure and which illustrate, by way of example, principles of inventions disclosed.

### DETAILED DESCRIPTION OF THE DRAWINGS

Notwithstanding any other forms which may fall within the scope of the disclosure as set forth in the Summary, specific embodiments will now be described by way of example and with reference to the accompanying drawings in which:

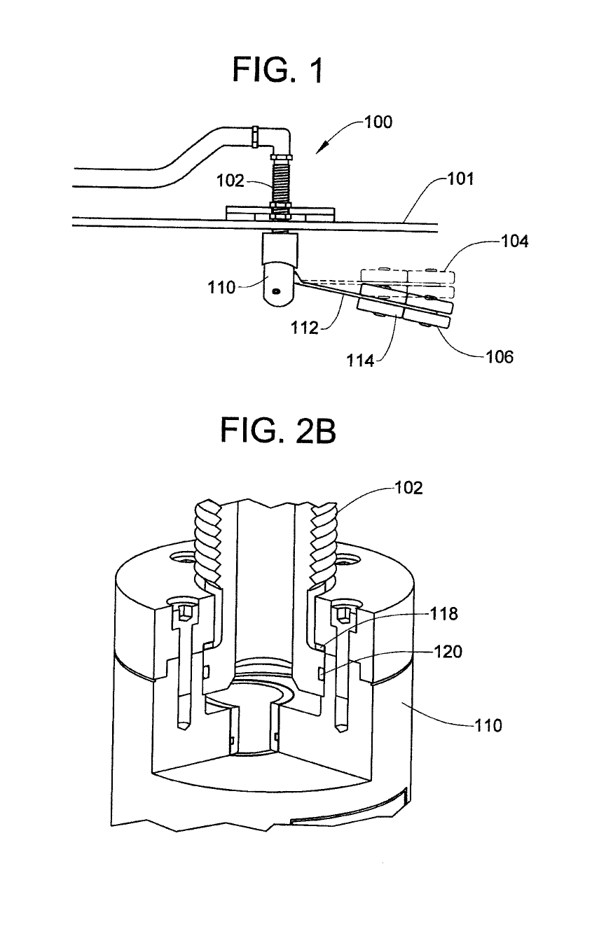

FIG. 1 illustrates an exemplary lever float valve mounted on a tank in accordance with exemplary embodiments described herein;

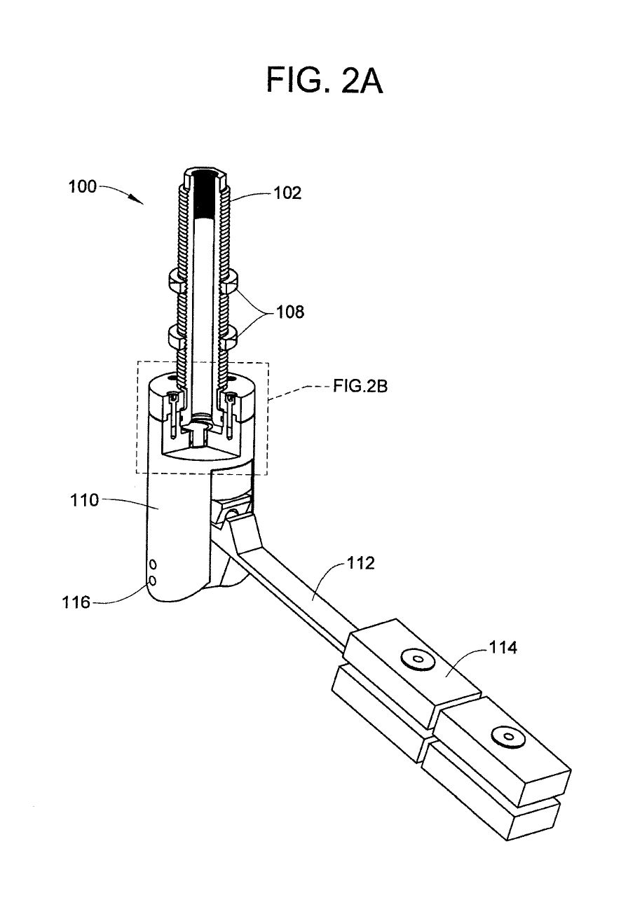

FIGS. 2A and 2B illustrate an exemplary lever float valve in accordance with exemplary embodiments described herein;

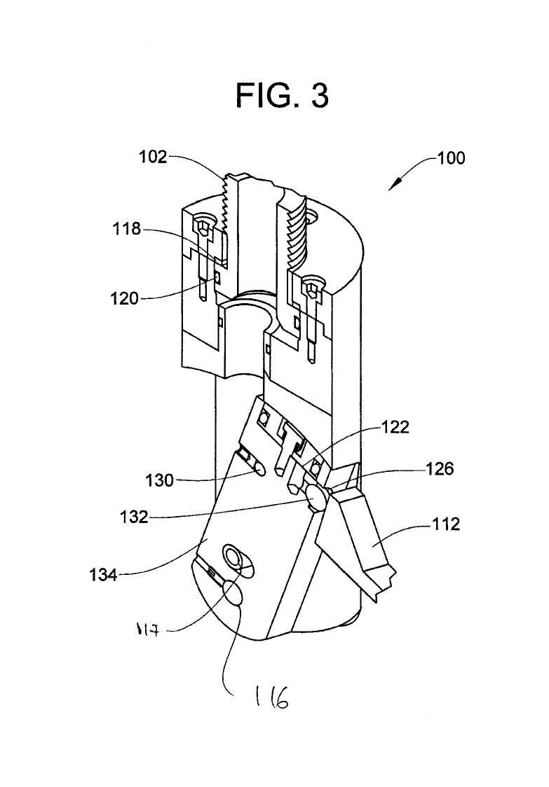

FIG. 3 is a cross-sectional view of an exemplary lever float valve in accordance with exemplary embodiments described herein;

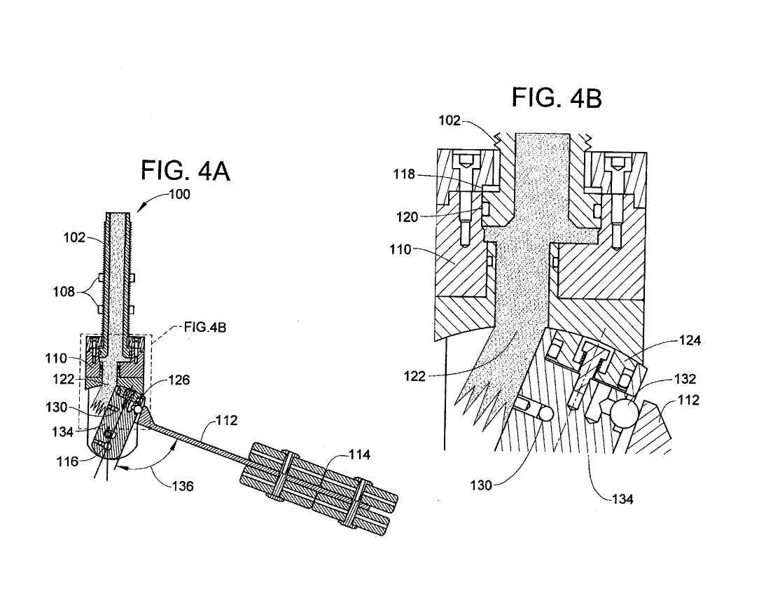

FIGS. 4A and 4B illustrate an exemplary lever float valve in a fully open configuration in accordance with exemplary embodiments described herein;

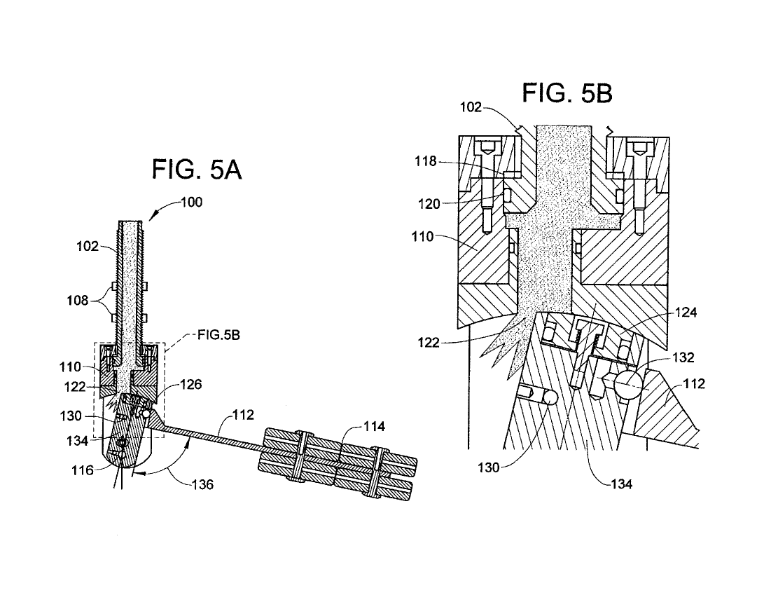

FIGS. 5A and 5B illustrate an exemplary lever float valve in a half open configuration in accordance with exemplary embodiments described herein;

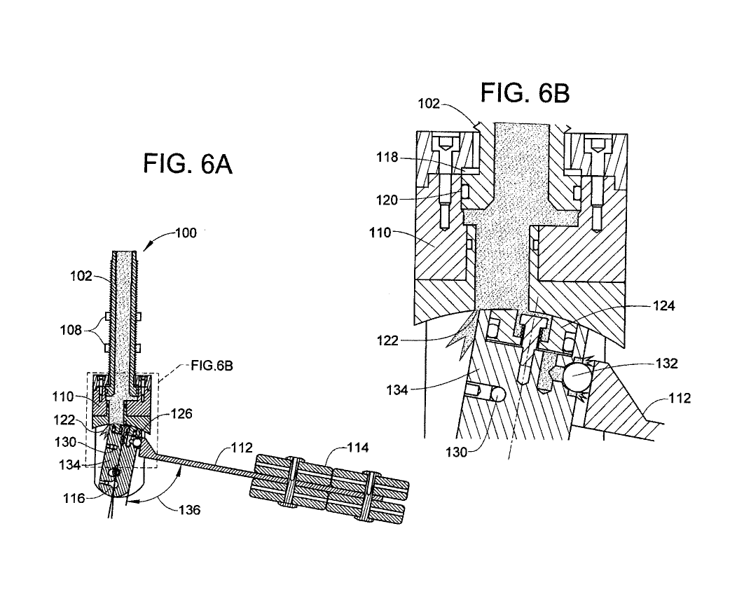

FIGS. 6A and 6B illustrate an exemplary lever float valve in a majority closed configuration in accordance with exemplary embodiments described herein;

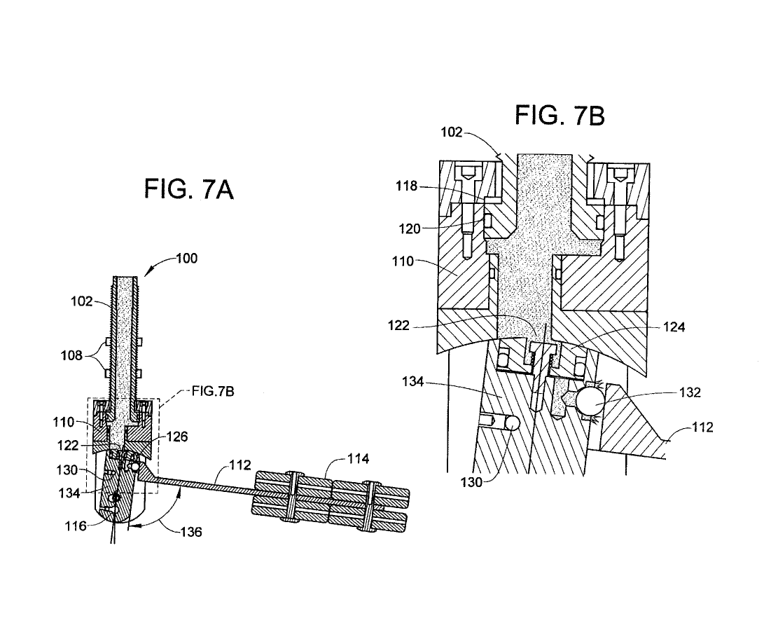

FIGS. 7A and 7B illustrate an exemplary lever float valve in an almost closed configuration in accordance with exemplary embodiments described herein;

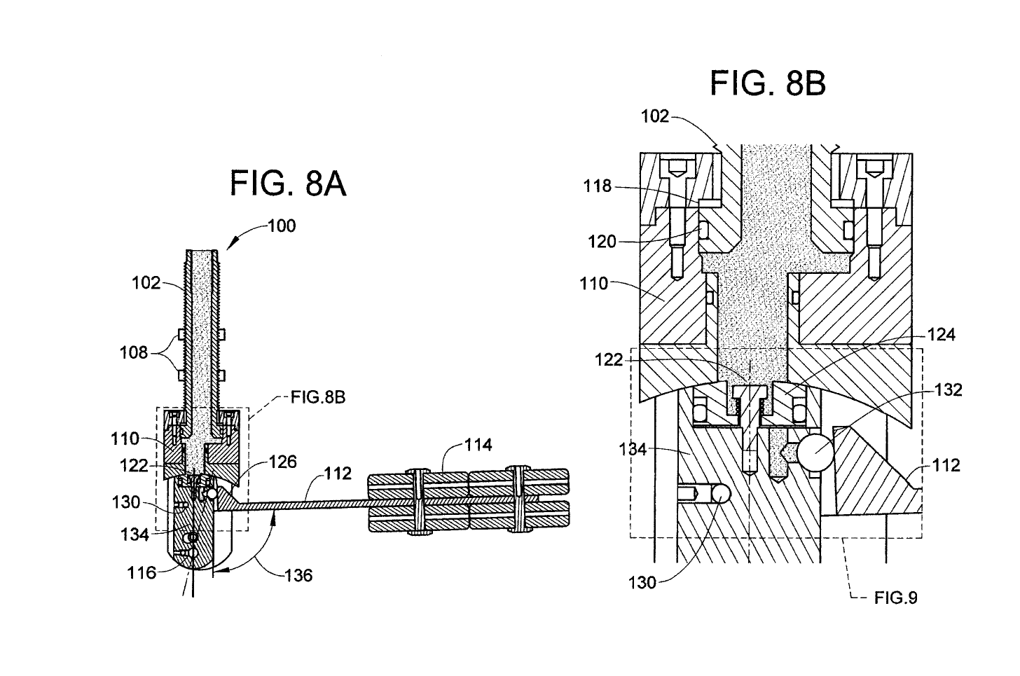

FIGS. 8A and 8B illustrate an exemplary lever float valve in a fully closed configuration in accordance with exemplary embodiments described herein;

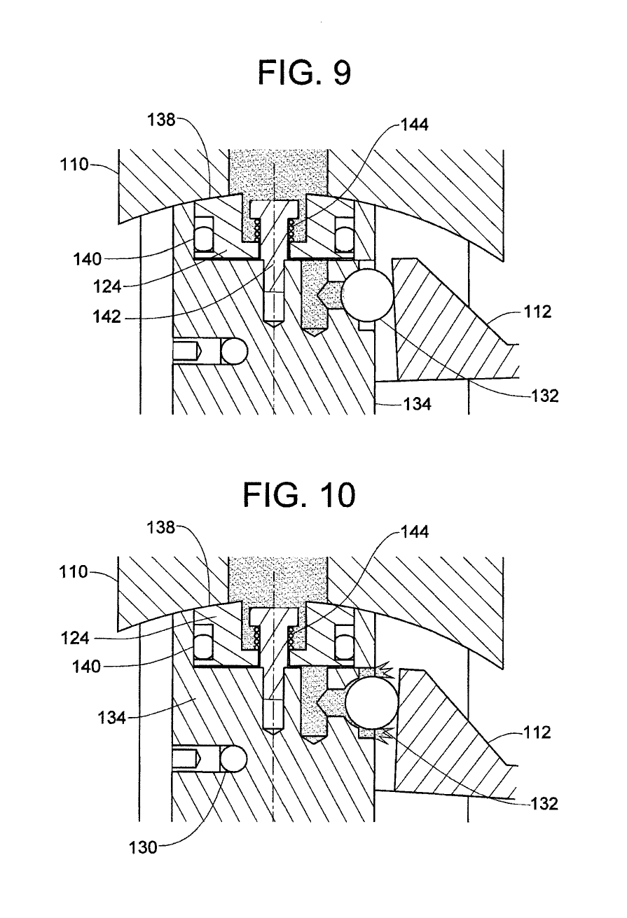

FIG. 9 is a cross-sectional view illustrating a hydraulic sealing mechanism of an exemplary lever float valve in accordance with exemplary embodiments described herein;

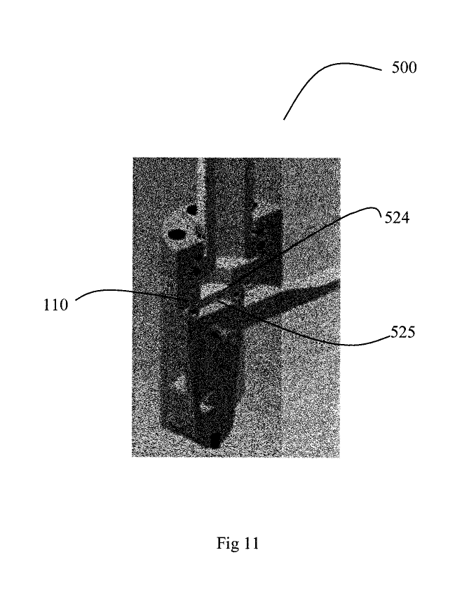

FIG. 10 is a cross-sectional view illustrating the hydraulic sealing mechanism the hydraulic opening of the secondary valve of an exemplary lever float valve in accordance with exemplary embodiments described herein; and

FIG. 11 is a cross sectional view illustrating an alternative embodiment of hydraulic sealing mechanism.

### DETAILED DESCRIPTION OF EXEMPLARY EMBODIMENTS

FIG. 1 illustrates an exemplary lever float valve mounted on a tank in accordance with exemplary embodiments described herein. As illustrated, the lever float valve 100 is mounted to a surface (for example, a top surface) of a tank 101. The lever float valve comprises a float stem 102, a float body 110 and a lever comprising an arm 112 and a float 114. The lever 112, 114 is configured in a manner that makes it possible for the lever to move from an open position 106 to a closed position 104 when the level of a fluid inside the tank reaches a certain level. In exemplary embodiments, the lever float valve 100 may be capable of being used in stationary and/or mobile applications and/or within tanks that comprise little to no baffling. In exemplary embodiments, the lever float valve 100 may comprise a pivot mechanism which allows positive shut off against significantly higher head pressures without effecting buoyancy. In exemplary embodiments, the lever float valve 100 may comprise a mechanism that enables the lever arm to swivel around a vertical access. In exemplary embodiments, the lever float valve 100 may comprise a swivel feature designed to reduce fuel surge inside tanks when they are moved. In exemplary embodiments, the lever float valve 100 may comprise a shear mechanism to produce fuel shut off, thereby allowing the device to withstand higher fuel pressures.

FIGS. 2A and 2B illustrate an exemplary lever float valve in accordance with exemplary embodiments described herein. The lever float valve 100 comprises a float stem 102, a float body 110 and a lever comprising an arm 112 and a float 114. In exemplary embodiments, the float stem 102 may comprise a mechanism for attaching the lever float valve 100 to a tank 101. For example, as shown in FIG. 2A, the attachment mechanism may be a pair of lock nuts 108. In exemplary embodiments, the lock nuts 108 can be threaded up and down the treads on the float stem 102 to control the position (for example, height) of the lever float valve 100 in the tank 101 and/or prevent rotation of the float stem 102. The float body 110 may be configured to be rotatable around a vertical axis of the lever float valve 100. In this manner, the lever (112, 114) can be located in multiple positions within the tank. In exemplary embodiments, the float body 100 may be attached to the float stem 102 with a thrust washer 118 and an O-ring seal 120. As illustrated in FIG. 2B, for example, the thrust washer 118 and O-ring seal 120 make it possible for the float body 110 to rotate about a central vertical axis of the float stem 102. However, when a fluid is introduced into the float stem 102, the stem body 110 may be forced downward such that rotation of the float body 110 may be substantially prevented. In addition, fluid flow between the float stem 102 and the float body 110 is facilitated without leakage because of the seal 120.

FIG. 3 is a cross-sectional view of an exemplary lever float valve in accordance with exemplary embodiments described herein. As illustrated in FIG. 3, the lever float valve 100 comprises a valve segment 134 located within the float body 110. In addition, the float body 110 comprises two pivots, a first pivot 116 and a second pivot 130. As will be described in more detail elsewhere, the first pivot 116 controls the movement of the valve segment 134 in a manner which allows the valve segment 134 to open and close a primary valve aperture 122 while the second pivot 130 controls the movement of the lever (112, 114) to open and close the secondary valve aperture 126. The stop 117 limits the extent of pivotal movement about the first pivot 116. As can be appreciated, the primary valve aperture 122 allows for the majority of fluid flow into the tank while the secondary valve aperture allows for much less fluid flow into the tank.

In exemplary embodiments, the lever float valve 100 may be better suited for use in mobile applications. For example, instead of a simple fulcrum design, the valve segment 134 may be more robust and/or less likely to fail in the case of, for example, a fuel surge. In addition, the lever float valve may be configured to accommodate higher fuel in flow rates. For example, in exemplary embodiments, the lever float valve 100 may be configured to accommodate about 2 litres/min (Lpm) of fuel flow. In exemplary embodiments, the lever float valve 100 may be configured to accommodate about 3 Lpm, 4 Lpm, 5 Lpm, 6 Lpm, 7 Lpm, 8 Lpm, 9 Lpm, and/or 10 Lpm of fuel (or liquid) flow. Additionally, the lever float valve may be configured to accommodate higher shut off pressures. For example, in exemplary embodiments, the lever float valve may be configured to accommodate shut off pressures exceeding 20 bar, 25 bar, 30 bar, 35 bar, 40 bar, 45 bar, 50 bar, 55 bar, 60 bar, 65 bar, 70 bar, 75 bar, 80 bar, 85 bar, 90 bar, 95 bar, and/or 100 bar.

FIGS. 4A and 4B illustrate an exemplary lever float valve in a fully open configuration in accordance with exemplary embodiments described herein. In the fully open configuration, the valve segment 134 is pivoted around pivot 116 such that the primary valve aperture 122 is fully open. Similarly, the lever (112, 114) is pivoted around pivot 130 such that the secondary valve aperture 126 is also fully open. In this configuration, the float arm 112 forms an angle with the valve segment 134 which is slightly less than 90 degrees and in operation, the fluid flows into the tank through the primary valve aperture 122.

FIGS. 5A and 5B illustrate an exemplary lever float valve in a half open configuration in accordance with exemplary embodiments described herein. As the fluid level in the tank begins to rise, the lever 100 begins to close. FIGS. 5A and 5B illustrate the lever float valve in a position that is approximately 50% open. Initially, the secondary valve is closed because of the buoyancy of the float 114. As a result the angle between the valve segment 134 and the float arm 112 is equal to, or slightly more than 90 degrees. In this embodiment, the secondary valve aperture 126 closes because the float arm 112 forces a ball (for example, a steel ball) 132 into the secondary valve aperture 122. In addition, the valve segment 134 has pivoted counter-clockwise around pivot 116 such that the primary valve aperture 122 is partially closed.

FIGS. 6A and 6B illustrate an exemplary lever float valve in a majority closed configuration in accordance with exemplary embodiments described herein. In these figures, the fluid level has risen further and the primary valve aperture 122 has closed further. As a result, fluid is permitted to enter the valve segment 134. Once the pressure of the fluid in the valve segment 134 exceeds the buoyancy of the float 114, the secondary valve aperture 126 is forced open and fluid begins to flow through the secondary valve aperture 126.

FIGS. 7A and 7B illustrate an exemplary lever float valve in an almost closed configuration in accordance with exemplary embodiments described herein. In FIGS. 7A and 7B, the valve segment 134 has rotated sufficiently to stop the flow of fluid through the primary valve aperture 122. Fluid continues to flow through the second secondary valve aperture 126.

FIGS. 8A and 8B illustrate an exemplary lever float valve in a fully closed configuration in accordance with exemplary embodiments described herein. In FIGS. 8A and 8B, the valve segment 134 has rotated sufficiently to stop the flow of fluid through the primary valve aperture 122. Additionally, the level of fluid in the tank 101 has caused the buoyancy of the float 114 to exceed the pressure of fluid entering the valve segment 134 which causes the secondary valve aperture 126 to close. Therefore, fluid flow into the tank stops.

FIG. 9 is a cross-sectional view illustrating a hydraulic sealing mechanism of an exemplary lever float valve in accordance with exemplary embodiments described herein and FIG. 10 is a cross-sectional view illustrating the hydraulic opening of the secondary valve of an exemplary lever float valve in accordance with exemplary embodiments described herein. When the primary valve aperture 122 and the secondary valve aperture 126 are both closed (as illustrated in FIG. 9), fluid is permitted to flow past the retaining bolt 142 and gathers under the sealing plug 124. The fluid pressure acting on the underside of the sealing plug 124 overcomes the spring force created by spring 144 (see, FIG. 10) as well as the fluid pressure on top of the sealing plug, which causes the sealing plug 124 to move vertically and press against a sealing surface of the body 110 to create a sealed joint 138. The final sealing occurs once the secondary valve aperture 126 is sealed thereby allowing the increased fluid pressure under the sealing plug 124. The sealing plug 124 is sealed relative to the valve segment with an O-ring 140.

In order to open the lever float valve 100, the fluid level in the tank 100 should drop down by a predefined amount (for example, approximately 8 mm, 9 mm, 10 mm, 11 mm, 12 mm, 13 mm, 14 mm) so that the lever (112,114) drops sufficiently and the secondary valve aperture 126 opens. When this valve opens, the volume of fluid below the sealing plug 124 depressurizes and the small spring force caused by spring 144 and the fluid pressure on top of the sealing plug 124 forces the plug away from the body 110, forcing the sealed joint 138 open. This enables the valve segment 134 to begin pivoting about pivot 116 as described above.

FIG. 11 illustrates an alternative embodiment of float valve 500 with a modified sealing plug arrangement. Sealing plug 524 differs from sealing plug 124 described above in that the retaining bolt and spring are omitted. The manner in which the sealing plug hydraulically seals the first valve segment is, in principle, the same. Fluid is able to pass through the sealing lug by way of aperture 525. When the first and second valve segments are closed, the effective area underneath sealing cap 524 upon which fluid can exert upwards pressure is greater than the area at the upper side of the sealing cap 524. This results in a net force which tends to bias the sealing cap 524 upwards as seen in the FIG. 11, which seals the sealing cap 524 against the valve body 110.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, for example, aspects of one embodiment may be combined with aspects of another embodiment to realize yet other embodiments. Further, each independent feature or component of any given assembly may constitute an additional embodiment.

1. A lever float valve comprising:
a float stem with a central vertical axis;
a float body coupled to the float stem and rotatable relative to the central vertical axis of the float stem;
a valve segment positioned within the float body and configured to pivot around a first axis perpendicular to the vertical axis; and
a lever comprising a float arm and a float coupled to the valve segment and configured to pivot around a second axis perpendicular to the vertical axis;
wherein, in operation, the valve segment rotates around the first axis to open and close a first valve aperture and the lever rotates around a second axis to open and close a second valve aperture.

2. The lever float valve of claim 1, wherein the rotation of the valve segment is independent of the rotation of the lever.

3. The lever float valve of claim 1, wherein the first axis and the second axis are positioned within the float body.

4. The lever float valve of claim 1, wherein the lever float valve is configured to substantially stop the flow of fluid through the float stem when a fluid level in a tank reaches a predetermined height.

5. The lever float valve of claim 1, wherein the lever float valve is mountable in a stationary tank.

6. The lever float valve of claim 1, wherein the lever float valve is mountable in a movable tank.

7. (canceled)

8. The lever float valve of claim 1, wherein, in operation, the first valve aperture and the second valve aperture are open when the fluid level is below a first predetermined level, the second valve aperture closes when the fluid level is above the first predetermined level, the second valve aperture opens when the fluid level is above a second predetermined level higher than the first predetermined level, the first valve aperture closes when the fluid level is above a third predetermined level higher than the second predetermined level, and the second valve aperture closes when the fluid level is above a fourth predetermined level higher than the third predetermined level.

9. The lever float valve of claim 1, wherein the valve segment further comprises a seal plug configured to engage a portion of the float body to substantially seal the first valve aperture closed.

10. The lever float valve of claim 1, wherein the lever float valve further comprises a ball configured to substantially seal the second valve aperture closed when the lever forces the ball into the second valve aperture.

11. The lever float valve of claim 1, wherein, in operation, the lever float valve opens when the fluid level falls below a predetermined level allowing the lever to pivot such that the second valve aperture opens thereby causing the seal plug to disengage with the float body so the valve segment is allowed to rotate.

12. The lever float valve of claim 7, wherein the fluid flow through the first valve aperture is significantly greater than the fluid flow through the second valve aperture.

13. A lever float valve, mountable to a movable fuel tank, the lever float valve comprising:
a float stem with a central vertical axis;
a float body coupled to the float stem and rotatable relative to the central vertical axis of the float stem;
a valve segment positioned within the float body and configured to pivot around a first axis perpendicular to the vertical axis to open and close a first valve aperture; and
a lever comprising a float arm and a float coupled to the valve segment and configured to pivot around a second axis perpendicular to the vertical axis to open and close a second valve aperture;
wherein the fuel flow through the first valve aperture is significantly greater than the fuel flow through the second valve aperture.

14. The lever float valve of claim 13, wherein the rotation of the valve segment is independent of the rotation of the lever.

15. The lever float valve of claim 13, wherein the first axis and the second axis are positioned within the float body.

16. The lever float valve of claim 13, wherein the lever float valve is configured to substantially stop the flow of fuel through the float stem when a fluid level in the fuel tank reaches a predetermined height.

17. The lever float valve of claim 13, wherein, in operation, the first valve aperture and the second valve aperture are open when the fluid level is below a first predetermined level, the second valve aperture closes when the fluid level is above the first predetermined level, the second valve aperture opens when the fluid level is above a second predetermined level higher than the first predetermined level, the first valve aperture closes when the fluid level is above a third predetermined level higher than the second predetermined level, and the second valve aperture closes when the fluid level is above a fourth predetermined level higher than the third predetermined level.

18. The lever float valve of claim 13, wherein the valve segment further comprises a seal plug configured to engage a portion of the float body to substantially seal the first valve aperture closed.

19. The lever float valve of claim 13, wherein the lever float valve further comprises a ball configured to substantially seal the second valve aperture closed when the lever forces the ball into the second valve aperture.

20. The lever float valve of claim 13, wherein, in operation, the lever float valve opens when the fluid level falls below a predetermined level allowing the lever to pivot such that the second valve aperture opens thereby causing the seal plug to disengage with the float body so the valve segment is allowed to rotate.

21. A lever float valve comprising:
a float stem with a central vertical axis;
a float body coupled to the float stem and rotatable relative to the central vertical axis of the float stem;
a valve segment positioned within the float body and configured to pivot around a first axis perpendicular to the vertical axis; and
a lever comprising a float arm and a float coupled to the valve segment and configured to pivot around a second axis perpendicular to the vertical axis;
wherein the first axis and the second axis are positioned within the float body.

22. The lever float valve of claim 21, wherein the rotation of the valve segment is independent of the rotation of the lever.

23. The lever float valve of claim 20, wherein the lever float valve is configured to substantially stop the flow of fluid through the float stem when a fluid level in a tank reaches a predetermined height.

24. The lever float valve of claim 20, wherein the lever float valve is mountable in a stationary tank.

25. The lever float valve of claim 20, wherein the lever float valve is mountable in a movable tank.

26. The lever float valve of claim 20, wherein, in operation, the valve segment rotates around the first axis to open and close a first valve aperture and the lever rotates around a second axis to open and close a second valve aperture.

27. The lever float valve of claim 20, wherein, in operation, the first valve aperture and the second valve aperture are open when the fluid level is below a first predetermined level, the second valve aperture closes when the fluid level is above the first predetermined level, the second valve aperture opens when the fluid level is above a second predetermined level higher than the first predetermined level, the first valve aperture closes when the fluid level is above a third predetermined level higher than the second predetermined level, and the second valve aperture closes when the fluid level is above a fourth predetermined level higher than the third predetermined level.

28. The lever float valve of claim 26, wherein the valve segment further comprises a seal plug configured to engage a portion of the float body to substantially seal the first valve aperture closed.

29. The lever float valve of claim 26, wherein the lever float valve further comprises a ball configured to substantially seal the second valve aperture closed when the lever forces the ball into the second valve aperture.

30. The lever float valve of claim 26, wherein, in operation, the lever float valve opens when the fluid level falls below a predetermined level allowing the lever to pivot such that the second valve aperture opens thereby causing the seal plug to disengage with the float body so the valve segment is allowed to rotate.

31. The lever float valve of claim 26, wherein the fluid flow through the first valve aperture is significantly greater than the fluid flow through the second valve aperture.

32. The lever float valve of claim 27, wherein the valve segment further comprises a seal plug configured to engage a portion of the float body to substantially seal the first valve aperture closed.

33. The lever float valve of claim 27, wherein the lever float valve further comprises a ball configured to substantially seal the second valve aperture closed when the lever forces the ball into the second valve aperture.

34. The lever float valve of claim 27, wherein, in operation, the lever float valve opens when the fluid level falls below a predetermined level allowing the lever to pivot such that the second valve aperture opens thereby causing the seal plug to disengage with the float body so the valve segment is allowed to rotate.

35. The lever float valve of claim 27, wherein the fluid flow through the first valve aperture is significantly greater than the fluid flow through the second valve aperture.
